(19) United States
(12) Patent Application Publication
(10) Pub. No.: US 2005/0225971 A1
(43) Pub. Date: Oct. 13, 2005

(54) Safety warning module

(76) Inventor: Michael Alan Melnik, Deerfield, MA (US)

Correspondence Address: GIFFORD, KRASS, GROH, SPRINKLE & CITKOWSKI, P.C, PO BOX 7021, TROY, MI, 48007-7021, US

(21) Appl. No.: 11/104,793

(22) Filed: Apr. 13, 2005

Related U.S. Application Data
(60) Provisional application No. 60/561,695, filed on Apr. 13, 2004.

(51) Int. Cl. F21L 4/00

(52) U.S. Cl. 362/202

(57) ABSTRACT

A self-powered safety module includes a pair of end lights and a ring of circumferential lights which are selectively energized by a pushbutton switch. The module includes a housing and an inner electronic module. The inner module includes an LED display for displaying time and temperature as well as a transceiver such as a cell phone and GPS unit which are activated by a switch for an emergency mode. The switch permits selection of one of a warning mode and an alert mode, or an SOS mode.

### RELATED APPLICATION

This application claims priority of U.S. Provisional Patent Application Ser. No. 60/561,695 filed Apr. 13, 2004, which is incorporated herein by reference.

### FIELD OF THE INVENTION

The invention relates to a safety module having lights which are selectively operable to indicate a warning or a safety alert. More particularly, the invention relates to a safety module which may be mounted to a flashlight and provide warning signals for oncoming traffic.

### BACKGROUND OF THE INVENTION

It is known to use flashlights or lanterns to illuminate pathways when walking at night. However, when walking in urban areas where there is traffic approaching from behind the user, a flashlight provides no indication of the presence of the user. Accordingly, it would be advantageous to provide a module for use with a flashlight which is easily seen from all directions to warn approaching vehicles.

### SUMMARY OF THE INVENTION

The invention is directed to a self-contained module having a cover and inner module containing two groups of lights. One group is a pair of lights which are directed through a top end of a covering. The group of lights is formed in a ring and is visible through a cylindrical sidewall of the covering. A pushbutton switch is operable to direct a control circuit to display the lights in preselected modes. The electronic module is also includes an electronic display, a clock and temperature device. Additionally, the module can be provided with a transceiver or cell phone type device and a GPS activated by an emergency switch. The module is mounted to a flashlight with an adapter. The module contains a power source and may be used separately from the flashlight.

### BRIEF DESCRIPTION OF THE DRAWING

FIG. 1 is a perspective side view of a module adapter and a conventional flashlight;

FIG. 2 is a perspective view of the safety module;

FIG. 3 is an exploded side view of the safety module showing the housing, electronic module and battery pack;

FIG. 4 is a side view of an opposite side of the inner module;

FIG. 5 is a side view of a first alternative preferred embodiment of the safety module of the invention; and

FIG. 6 is a partial perspective view of the end of the first alternative preferred embodiment of the invention.

### DETAILED DESCRIPTION OF THE INVENTION

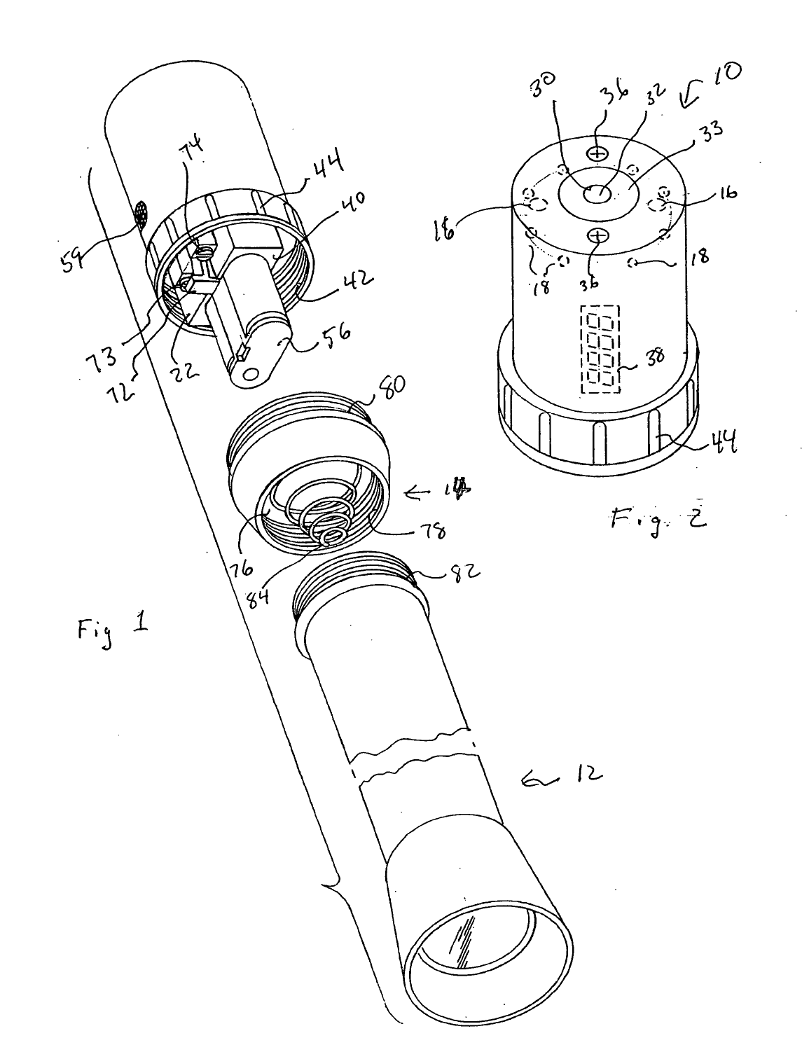

As shown in FIG. 1, a first preferred embodiment of the invention is a safety warning module 10 mounted to a conventional flashlight 12 by an adapter 14. Although shown mounted to the flashlight 12, the module is self-contained and may be used separately or mounted to a variety of devices, such as wheelchairs, bikes, etc. The safety module has two groups of lights which may be selectively operated in predetermined modes to provide alerts or warnings. The module is also provided with electronic safety items as discussed herein. One group of lights is a pair of bright lights 16 and another group is of eight smaller lights which are disposed in a ring.

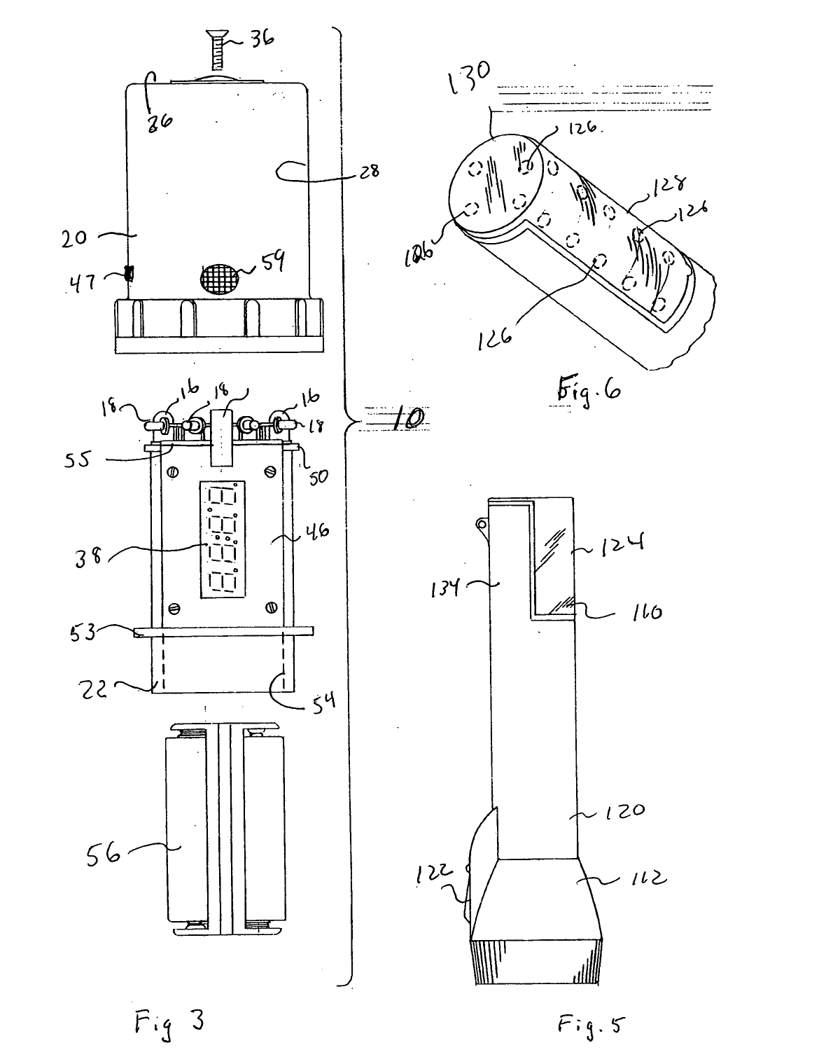

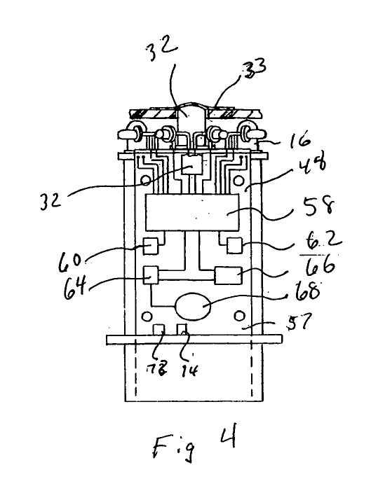

As shown best in FIG. 3, the module 10 includes an inner module mounted in a cup-shaped housing 20. The inner module 22 includes a rectangular base 24 to which electrical components are mounted. As shown in FIGS. 3 and 5, the base 24 is generally in the form of a rectangular box having two wide sidewalls 46, 48, a top end 50, and a lower end 52. The lower end 52 has an opening 54 in the opposite end. The opening 54 is formed to receive a battery pack 56 which is slid into the opening 54. The module is thus self-powered. A solar cell to recharge the battery may be mounted to the housing. A circular flange 53 is formed to extend to an inner surface of the housing to position the inner module within the housing.

As shown in FIGS. 1, 2 and 3, the housing 20 has a generally flat top surface 26 and cylindrical wall 28 molded of transparent material. In the preferred embodiment, the housing 20 is formed of a red acrylic. The top surface 26 has a center hole 30 for receiving the pushbutton switch 32. A pair of apertures 34 are formed for screws 36 to secure the inner module 22 to the housing 20. The housing is transparent so that the lights 16, 18 and a display 38 may be viewed through the housing 20. The cylindrical wall 28 has open end 40 with internal threads 42 for mounting to the adapter 14. Ribs 44 are formed on an outer surface of the end 40 to facilitate mounting of the housing to the adapter. When a transceiver is incorporated into the unit, the cover has a hole in the sign for an emergency switch 57 to operate the phone and several small openings 59 covered on the inside with a water-resistant membrane to permit sound to be transmitted to and received from the microphone/speaker.

As shown in FIGS. 2 and 3, the pair of end lights 16 and eight side lights 18 are mounted to a board 55 positioned on the top end 50 of the base. The lights 16, 18 are preferably in the form of red LEDs and are mounted to be visible through the covering. The end lights 16 are much brighter and visible through the top surface 26 so that the module can be clearly seen from behind. The eight side lights 18 are spaced around the circumference of the top surface 50 in a ring to be visible out of both from the top surface 26 but also through the cylindrical wall 28. The second group of lights 18 can thus be seen from any direction. The lights 16, 18 preferably have high visibility and low power such as light emitting diodes (LEDs). The switch 32 is a pushbutton switch which can be held for discrete periods of time to operate the switch in various components of the module 10. The switch may be provided with a cover to make the module watertight. A suitable switch is made by ______. The pushbutton switch 32 is mounted to extend through the center hole 30 to operate the lights and other components of the module as discussed more fully below. A pair of spacers 58 are provided to space the top end 50 from the top surface of the covering to provide space for the lights 16, 18 and switch 32.

As shown in FIG. 4, the control circuit 58, as well as a clock 60 and electrical thermometer 62 are mounted to a board 55 which is mounted on sidewalls 48. The clock and thermometer are connected to the control circuit and to the display 38 which is mounted on the other side 47. Additionally, a transceiver 64 such as used in a cell phone and a GPS unit 66 may be mounted on the side 46. A microphone/ speaker 68 for the transceiver is also mounted to the side 46 to be aligned with openings 20 formed in the housing. An emergency switch 57 is mounted in the housing to operate the transceiver. Other accessories such as a digital camera, biological and chemical sensors, as well as heart and blood pressure monitors may be added. The lights 16, 18 and switch are electrically connected to a control circuit 58.

The control circuit includes a microchip which is programmed to act in response to the switch to cycle through a number of modes of operation. One short press of the pushbutton places the module in a steady mode where the two end lights 16 are energized. This mode is particularly useful for walking at night when using a flashlight. When the flashlight is directed to the ground ahead of the user, the end lights 16 are visible from behind to warn traffic of the presence of the user. A second short press directs the controller to the alert mode where the end lights 16 and side lights 18 flash sequentially. Another short press cycles the controller 58 to an SOS mode in which all of the lights 16, 18 will flash an SOS pattern to alert individuals as to an emergency condition.

The emergency switch 57 directs the controller 58 to move to an emergency mode at which time the GPS unit 66 is activated and the transceiver 64 is activated. The transceiver 64 is programmed to dial 911. After connecting to 911, the user can speak through the openings 59 in the housing to the microphone/speaker 68 to an emergency operator to provide the emergency operator with the nature of the emergency. At the same time the display 38 will provide the latitude and longitude coordinates which the user can provide to the emergency operator. In some transceivers 14 the GPS information will be accessible directly by the emergency personnel.

As shown in FIG. 1, a contact switch 22 for initiating adjustment of the clock 60 is positioned at the bottom end of the base. Holding a contact switch 22 for two seconds will energize the adjustment mode. A pair of mode buttons 73, 74 are provided to change the adjustment mode. One button is provided to change the hour, the other the minute. A time and temperature display mode is activated by holding the pushbutton of the switch for approximately one second. The time and temperature will display in alternate form on the display 38 in all modes. The battery power is also displayed through the monitor along with a sound indicating low battery strength.

As shown in FIG. 1, the adapter 14 is circular with a radially extending wall 76 separating a first threaded portion 78 and a second threaded portion 80. The first threaded portion 78 is formed to engage threads 82 on the end of the flashlight 12 to which an end cap (not shown) is normally mounted. The adapter 14 is mounted to the flashlight instead and is provided with a spring 84 to connect the batteries (not shown) of the flashlight 12.

If the module is installed on a flashlight not using the end cap for access to the batteries, it will not be necessary to use the coil spring on the adapter. In some cases, the adapter may have an attachment device such as a sleeve which can be tightened over the end of the flashlight. A number of suitable attachment arrangements are within the contemplation of the invention. Additionally, it is not necessary to mount the module 10 on a flashlight. The module 10 may be mounted to a tubular handle which could be carried in the same fashion as a flashlight. The tube may be formed so that it is strapped onto the arm or leg of the user or to other devices such as vehicles, wheelchairs and the like. Finally, the module may be separate. The module is self-powered and may be placed on a window ledge or on the dashboard of a car to indicate a problem.

A first preferred alternative embodiment of the safety module 110 is shown in FIGS. 5-6 as part of a flashlight 112. This embodiment is a device generally in the form of a flashlight having both a conventional flashlight assembly 114 at one end and an emergency flashing or non-flashing warning light 116 at the other end. The safety module may be handheld for walking, hiking, or performing certain jobs at night such as traffic direction, etc. or as a safety lamp placed on a surface or the ground.

The flashlight assembly 114 has a lens holder having a flat surface 118 permitting the flashlight to be placed on the flat surface to support a handle 120 in a vertical position with the warning light at the top. The handle portion has an upper side having a switch 122 and a warning light shield 124 at the other end. A warning light assembly is mounted to the body beneath the shield.

The warning light assembly includes a lens 128 covering one or more highly visible flashing lights 126 such as an LED. The lens has a semi-cylindrical portion 130 extending to a disk portion 132 which extends normally from the semi-cylindrical portion 130 to cover the end of the flashlight. The semi-cylindrical portion extends under a shield portion 134 of the handle to cover a cavity containing the warning light bulb or LEDs. Light is permitted to pass through both the disk and the semi-cylindrical portion of the lens.

The handle 120 contains a battery compartment as a conventional flashlight. The flashlight end is removable to access the battery compartment. The switch is positioned on the upper side of the handle adjacent the flashlight assembly. The switch has a slide which moves longitudinally from the front through three positions from “off”: (1) flashlight only, (2) both flashlight and safety light, and (3) safety light only.

When used for walking etc. at night, the flashlight is held in a conventional position with the handle and flashlight assembly angled at the ground ahead of the walker. Because the flashlight is held at an angle with respect to horizontal, the disk and semicircular portion of the lens are visible to vehicles approaching from behind and on both sides of the user. The shield portion 134 of the handle blocks light from the warning light from the user.

Thus disclosed is a novel safety warning module which can be installed on a conventional flashlight providing a warning to approaching vehicle in the presence of a pedestrian, jogger, bike rider or the like. The module provides a shielded light which flashes brightly in the direction of the approaching vehicles yet is occluded from the user's eyes. A number of electronic accessories may be provided.

1. A safety module comprising:
a housing having a transparent end surface and a transparent side surface, at least one light mounted to an inner module within the housing to be visible through the end surface when energized, at least one second light source mounted to an inner module and being visible through said transparent side surface when energized;
a switch operable to selectively actuate said first and second lights; and
a power source contained within said housing.

2. The safety module of claim 1 further comprising a control circuit, said control circuit connected to said switch to energize said lights according to one of a plurality of predetermined modes.

3. The safety module of claim 1 comprising a transceiver unit mounted to the inner module, said transceiver unit connected to said control circuit, said transceiver operable to connect to an emergency response person.

4. The safety module of claim 1 wherein said module includes an electronic display and a clock for displaying time on said display.

5. The safety module of claim 2 wherein said plurality of predetermined modes comprise a first mode in which the first and second light sources are both energized, a second mode in which only the at least first light source is energized; and a third mode in which the at least one second source is energized.

6. The safety module of claim 5 wherein the housing has a mounting mechanism.

7. The safety module of claim 6 wherein the mounting mechanism is adapted to mount to an end of a flashlight.

8. The safety module of claim 5 wherein said housing further comprises an opaque portion opposite the transparent side surface to shield the at least one second light source from a user.

9. The safety module of claim 3 wherein the transceiver unit is a cellular phone mounted in said housing.

10. The safety module of claim 1 further comprising a chemical detector mounted in said housing.

11. The safety module of claim 5 further comprising, a solar cell for noncharging the power source.

12. The safety module of claim 1 further comprising, a global positioning system, the global positioning system displaying a position of a user on the electronic display.

13. A safety module adopted for mounting to a flashlight, said module comprising:
a housing having a transparent end surface and a transparent side surface, at least one light mounted to an inner module within the housing to be visible through the end surface when energized, at least one second light source mounted to an inner module and being visible through said transparent side surface when energized;
a switch operable to selectively actuate said first and second lights;
a power source contained within said housing; and
a control circuit connected to said switch to energize said lights according to one of a plurality of predetermined modes.

14. The safety module of claim 13 comprising a transceiver unit mounted to the inner module, said transceiver unit connected to said control circuit, said transceiver operable to connect to an emergency response person.

15. The safety module of claim 13 wherein said module includes an electronic display and a clock for displaying time on said display.

16. The safety module of claim 13 wherein said plurality of predetermined modes comprise a first mode in which the first and second light sources are both energized, a second mode in which only the at least first light source is energized; and a third mode in which the at least one second source in energized.

17. A safety module comprising:
a housing having a transparent portion at least one light mounted to an inner module within the housing to be visible through the transparent portion when energized;
a control circuit operable to activate the at least one light to provide a warning signal; and
a transceiver operable to place emergency calls.

18. The safety module of claim 17 wherein the control circuit is connected to a switch to energize said lights according to one of a plurality of predetermined modes.

19. The safety module of claim 17 wherein said module includes an electronic display and a clock for displaying time on said display.

20. The safety module of claim 17 wherein the housing has a mounting mechanism.
